(19) United States
(12) Patent Application Publication
(10) Pub. No.: US 2013/0271465 A1
(43) Pub. Date: Oct. 17, 2013

(54) Sort-Based Tiled Deferred Shading Architecture for Decoupled Sampling

(71) Applicants: Franz P. Clarberg, Lund (SE); Robert M. Toth, Lund (SE); Karthik Vaidyanathan, Berkeley, CA (US)

(72) Inventors: Franz P. Clarberg, Lund (SE); Robert M. Toth, Lund (SE); Karthik Vaidyanathan, Berkeley, CA (US)

(21) Appl. No.: 13/992,410

(22) PCT Filed: Dec. 30, 2011
(86) PCT No.: PCT/US11/68023

§ 371 Date: Jun. 7, 2013

(51) Int. Cl. G06T 15/80

(52) U.S. Cl. CPC G06T 15/80
USPC 345/426

(57) ABSTRACT

A graphics pipeline combines the benefits of decoupling sampling with deferred shading. In the rasterization phase, a shading point is computed for each sample. After rasterization is finished, the shading points are sorted to extract coherence and groups of shading points shaded. This enables high sampling rates with efficient reuse of shading, in addition to other unique benefits.

### BACKGROUND

This relates generally to graphics processing.

Stochastic rendering of motion blur and depth of field is desirable to increase realism and improve the image quality. However, high visibility sampling rates are necessary to reduce the noise resulting from stochastic sampling to acceptable levels. High sampling rates are also required for high-quality spatial antialiasing, which is an important factor in increasing the visual fidelity of real-time graphics.

With high visibility sampling rates, pixel shading can become a major bottleneck. To keep the shading cost low, it is critical to decouple shading from visibility and reuse shading over multiple visibility samples, which may be spread out spatially over the image. It is also important to defer shading to be done as late as possible in the pipeline, in order to avoid shading samples that will ultimately be occluded. Deferred shading, often used in games, is optimal in this sense as only the final visible samples are shaded. However, none of the known decoupling mechanisms are specifically designed to work with deferred shading, which makes shader reuse difficult. Additionally, the bandwidth to the G-buffer may be high in traditional deferred shading.

### BRIEF DESCRIPTION OF THE DRAWINGS

Some embodiments are described with respect to the following figures:

FIG. 1 is an architectural overview of one embodiment;

FIG. 2 is a flow chart for one embodiment showing rendering of primitives in one tile; and

FIG. 3 is a schematic depiction of one embodiment.

### DETAILED DESCRIPTION

We address the problem of efficient decoupling and reuse of shading in real-time graphics pipelines. Our goal is to support high visibility sampling rates and stochastic effects, while only shading a minimal set of visible samples. For this purpose we defer shading until after rasterization, and sort the generated visibility samples to extract coherence. To make this efficient, our architecture operates over tiles to keep all data on chip, and each visibility sample only holds a compact reference to a shading point.

Explicit sorting of the samples post-visibility has some unique benefits in some embodiments. First, no shader caching mechanism is necessary, reducing hardware complexity. Second, the deferred shading will still be done in triangle order, which enables late shading of triangle attributes, and makes traditional per-triangle interpolation setup possible. It also allows state changes during rendering, making the application agnostic to the use of deferred shading, thus avoiding the need for a single uber-shader. The drawback is in the on chip memory and bandwidth required for sorting, but these costs are constant and independent of scene complexity, so a good fit for hardware implementation.

We propose a novel tiled (sort-middle) hardware architecture that combines the benefits of decoupled sampling with deferred shading. Our architecture is designed for efficient deferred shading with high visibility rates and samples stochastically distributed over the image, lens, and time, while minimizing off-chip bandwidth usage. For each tile, the forward pass stores a shading point, rather than a full G-buffer entry, with each visibility sample. The shading point consists of a primitive identifier and a shading coordinate. In some embodiments, the shading coordinate is encoded in Morton order. In the resolve pass, an on-chip radix sort of the shading points in a tile generates a coherent list of groups of shading points to be shaded. In some embodiments, these groups are quadrilaterals so that derivatives may be approximated by finite differences. In some other embodiments, groups are single shading points, such that the shading points are shaded individually. Quadrilaterals will be used as anon-limiting example. These are dispatched to the shader cores using existing mechanisms, for example, a reorder buffer used in some graphics processors. The only modification is that the result may be scattered out to an array of samples instead of just one pixel, before the quadrilateral is retired.

In the forward pass, the shading coordinate may be computed using the same mapping strategy as existing shader caching-based solutions, for example [Ragan-Kelley et al., Decoupled Sampling for Graphics Pipelines, ACM Transactions on Graphics, vol. 30(3), 2011]. The input to our algorithm is a dense set of visibility samples, out of which we find a representative set of shading points. This enables reuse of shading across multiple samples, even if these are spread out spatially. The generation of the input samples is orthogonal to our work, but we look at it from the perspective of a future graphics hardware pipeline including an efficient stochastic rasterizer.

Spatio-temporal occlusion culling is important to reduce the cost of rasterization and the associated depth buffer bandwidth. However, it does not reduce the number of shader executions. Our architecture is orthogonal to the use of occlusion culling, as culling occurs before rasterization, and a real system would likely integrate a variant of spatio-temporal occlusion in the pipeline.

In the resolve pass, all shading points are sorted, e.g., using a radix sort. Radix sort is a straightforward method for quickly sorting key-value pairs that is well suited for hardware implementation. The algorithm looks at digits of a fixed size, and performs a predetermined number of passes through the data. Other sorting algorithms may also be used.

Since no shader caching mechanisms are used, all data can be easily streamed without stalls and complex synchronization. The sorting step ensures quadrilaterals are shaded in the same order as in normal static rendering, which ensures good texture cache locality. Additionally, since triangles are shaded in order, vertex attribute shading and standard per-triangle interpolation setup can be done in the deferred pass, reusing existing hardware for this. This is a key difference to a shadercaching-based deferred shading solution. It also means that state changes are possible, e.g., switching pixel shaders mid-stream, avoiding the need for a single uber-shader and making the deferred shading largely transparent to the user. The presented architecture is useful also for non-stochastic rendering, as it essentially provides hardware-supported multi-sample anti-aliasing (MSAA) with the benefits of deferred shading.

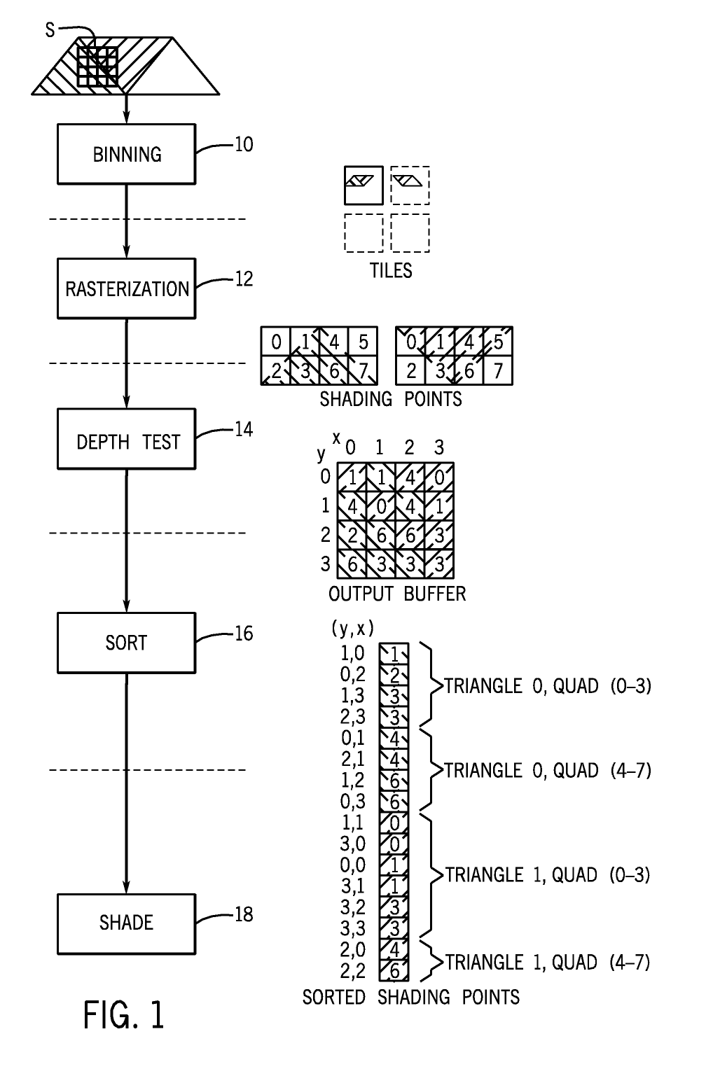

In FIG. 1, we are stochastically rendering triangles that move from left to right. The square “S” represents a tile into which we have binned (block 10) two triangles. These triangles are rasterized (block 12) to produce visibility samples inside the tile. Each visibility sample is mapped to a shading point on the primitive it hits. A shading point includes a triangle identifier and a coordinate for a shading position, which may be a Morton-order coordinate (the number inside the boxes labeled shading points). A Morton-order coordinate uses interleaved x and y bits. One triangle identifier is indicated by shading lines from upper left to lower right, and another by shading lines from lower left to upper right.

The shading points of samples that survive the depth test (block 14) are written to the output buffer. In the deferred shading pass, all shading points are sorted (block 16), as shown on the right. Each shading point stores the sub-pixel location in the tile (x, y) that its result should be written to. The list is sequentially scanned, and shading quadrilaterals dispatched for pixel shading (block 18) as they are found. The shading quadrilaterals will appear in the same order as in normal forward rendering. Hence, each time a new triangle is encountered, vertex attribute shading and triangle setup can be performed using existing hardware. When a quadrilateral is completed, its shaded results are scattered to the list of sub-pixel locations associated with its shading points.

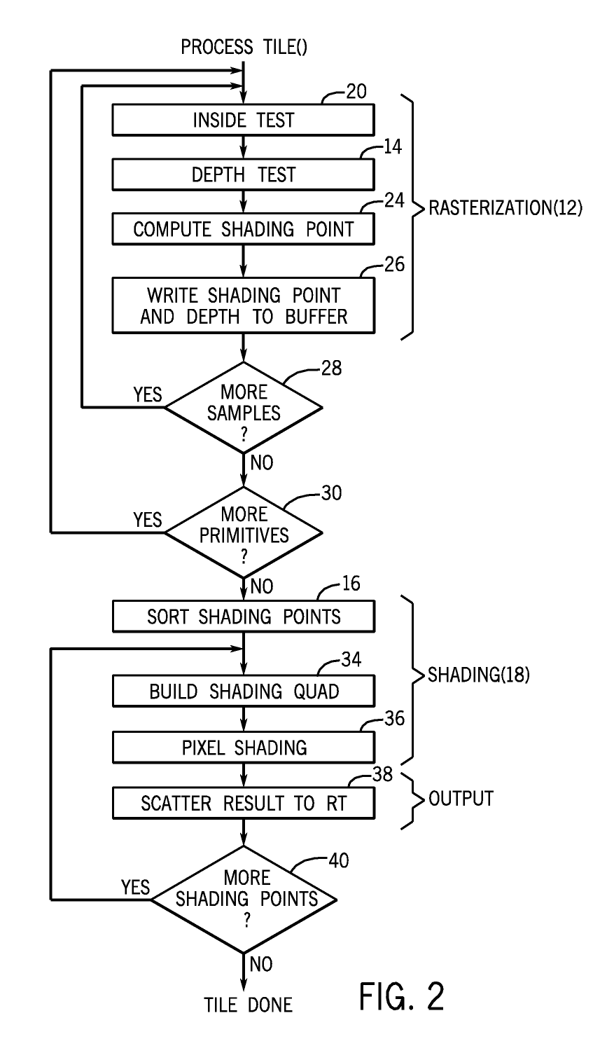

FIG. 2 shows a flow-chart describing the operations performed when processing a tile. Each tile represents a screen space region and holds a list of primitives to be rendered to this region. The tiles are generated by binning all primitives to the tiles they overlap. For generality, a tile may refer to the entire screen space area if binning is not used.

The first part (blocks 20, 14, 24, and 26) of the algorithm performs rasterization 12 of all primitives in the tile, writing out shading points to a local buffer. In the second phase, all shading points are sorted and subsequently shaded.

Compared to the traditional forward rasterization pipeline, the order of operations is modified so that all rasterization 12 is performed prior to shading 18. In the rasterizer 12, inside tests (block 20) are performed to compute visibility samples for each primitive. A shading point is computed (block 24) for each visibility sample using an arbitrary mapping function. The shading points are finally written to a buffer (block 26). Rasterization is complete when no more samples are found at diamond 28 and no primitives are found at diamond 30.

After rasterization completes, these shading points are sorted (block 16). Quadrilaterals (block 34) found by scanning the list are then shaded (block 36). The result of pixel shading is scattered to the list of sub-pixel locations (block 38) associated with each quadrilateral, rather than written to a single pixel (or coherent array of multi-samples with MSAA) in the traditional pipeline. The depth test 14 may be performed before (as shown) or after computing the shading point, but it is always performed before pixel shading. While this is usually desirable to avoid unnecessary work, it prevents shaders from computing custom depth. This limitation can be overcome by invoking a depth-computing shader in the rasterization loop, much like the shader computing G-buffer entries in deferred rendering implementations on forward rendering pipelines. The flow ends when no more shading points remain as determined at diamond 40.

To keep off-chip bandwidth at a minimum, our algorithm operates locally over multiple tiles on screen in some embodiments. Otherwise sorting of the visibility samples may require several round trips to global memory.

The specific binning strategy used is orthogonal to the rest of our algorithm. We propose binning just the bounding boxes of draw calls first. For each tile, we then have a list of all potentially overlapping geometry, and we can compute an upper bound on the memory footprint needed to store the binned triangles. Tiles with a high depth complexity may also be speculatively subdivided. The individual triangles are then binned to the screen space tiles. This requires the position-part of the vertex shader to be executed, in order to compute the bounding boxes of the moving/defocused triangles. We do not need to compute or store the remaining vertex attributes. These may be computed later, if needed.

The tile size is chosen appropriately; larger tiles need more memory and bandwidth, while smaller tiles increase the bin spread, i.e., the number of tiles each triangle overlaps. At 64×32 pixel tiles, the bin spread with defocus and motion blur is often limited to 2-3 on realistic scenes. As vertex shading and the associated bandwidth is assumed to be a relatively small part of the total cost in a 5D stochastic rasterizer, this should not be a limiting factor. At 64×32 pixels, each tile holds 32k visibility samples at 16 samples per pixel. This number will be used as anon-limiting example.

For each tile, we stochastically rasterize all binned triangles. Any stochastic rasterization algorithm may be used, such as an efficient hierarchical traversal. The rasterizer works against a small local on-chip depth and output buffer for the tile. These are assumed to be 4 bytes/sample each, for a total of 32k·8B=256 kB with 64×32 pixel tiles.

For each generated visibility sample that survives the depth test, a mapping function is evaluated to compute the corresponding shading point. A general mapping can be expressed as a 3×3 matrix transform followed by normalization. The mapping function may, for example, map the (x,y,u,v,t) parameters of the sample to a screen-space pixel coordinate (x,y) on the static triangle at u=v=t=0, at which the shading should be computed. Many visibility samples usually map to the same shading coordinate.

We compactly encode the shading point and store it to the output buffer. A simple example of an encoding may be a combination of a triangle identifier (e.g., 21 bits) and the screen-space pixel coordinate of the shading position relative to the tile (e.g., 6+5 bits for x and y). The shading position is stored in Morton-order (x and y bits interleaved) to maximize shading coherence. In practice, we may want to increase the shading point precision to, e.g., allow for limited bilinear interpolation between the shaded values. In the pathological case, when a tile holds more triangles than the ID range can encode, the rasterization and shading phases can be iterated. This results in a performance hit, that may be avoided by the application.

After rasterizing all triangles in a tile, we have a tile output buffer where each sample holds a triangle identifier and a coordinate for the shading position, which we jointly refer to as a shading point. This buffer is passed to the shading stage. The depth buffer is not kept, unless needed for other purposes.

The shading phase starts by sequentially sorting all shading points in the tile. This may be done using an on-chip radix sort or other sorting algorithm. The sorting key is the shading point (e.g., 32 bits) and the value is the sub-pixel position of the sample within the tile (e.g., 15 bits for 64×32 tiles at 16 samples/pixel). Although sorting the samples sounds expensive, an estimate below shows that the on-chip bandwidth should be manageable. The radix sort can be built as a small fixed-function unit that operates against dedicated on-chip buffers.

After sorting we have a list of shading points, hopefully with many duplicates. This list is sequentially scanned, and whenever a shading point not included in the current quadrilateral is found, a new quadrilateral is started and the previous is ready for dispatch to pixel shading. This is very similar to how the current rasterizer operates, except that scan conversion is replaced by a sequential scan to find shading quadrilaterals. No complex caching or reference counting is needed. We can hopefully reuse the existing hardware buffers that hold quadrilaterals in flight.

Note that with the proposed encoding of triangle identifier and Morton-order shading coordinate, shading quadrilaterals will be generated in the same order as in a traditional forward rasterizer. Hence, all quadrilaterals from one triangle will be generated before quadrilaterals from the next. We can exploit this in at least two ways. First, vertex attribute shading may be deferred. Whenever a new triangle is encountered, we request its vertices from the existing hardware vertex cache. Cache misses results in the vertex shading being executed, just like in the normal pipeline. Hence, we do not need to compute or store vertex attributes in the initial binning process, only positions. Hence, vertex attribute shading is only done for triangles that are visible in the final image, which is an added benefit compared to existing methods. Second, a traditional triangle interpolation setup can be performed when a new triangle is encountered in the list of shading points. Hence, the pixel shader operates just like in the normal forward pipeline, interpolating attributes using gradients precomputed in the triangle setup.

When a quadrilateral completes shading, the result is written to all sub-pixel locations that were assigned to the same quadrilateral. Due to the sorting, these locations are found as a linear array of sub-pixel coordinates, i.e., each of the shading points holds as value its unique sub-pixel location. The sub-pixel locations can belong to different pixels. This differs from the normal pipeline, where each result is only written to one pixel (or set of multi-samples inside a single pixel). Since each sub-pixel coordinate occurs exactly once, the hardware does not have to worry about conflicting writes. This means that no score-boarding or other synchronization mechanism is needed to order the writes, which could simplify the hardware design. As the writes may be scattered spatially within the tile, however, it may be useful to include a write coalescing unit that operates against the local buffer, before the tile is resolved and written out to main memory after all shading is complete.

The radix sort performs a fixed number of passes through the data, e.g., with 11 bit digits and 32 bit keys we will do three passes. Each pass will read the elements twice and write once (i.e., first build a histogram, and then reorder the elements). With this setup, the on-chip bandwidth for sorting a tile is 960 kB read and 576 kB write, ping-pong'ing between two local 192 kB buffers. For tiles that have fewer triangles, we can possibly reduce the number of passes to one or two, saving ⅔ or ⅓ of the bandwidth, respectively. In total, for 1920×1080 pixels rendering at 60 Hz, we would need up to 56 gigabytes per second (GB/s) read+34 GB/s write speed. This should be feasibly given the small size of the buffers and streaming read/writes. For comparison, L1/L2/L3 caches commonly already have hundreds or thousands of GB/s bandwidth, and they allow much more incoherent accesses.

We have designed our architecture to determine how decoupled sampling can be combined with the benefits of deferred shading, and whether it is possible to avoid a potentially complex shader caching mechanism. A motivation for some embodiments comes from minimizing off-chip memory bandwidth, which is very expensive in terms of power consumption. Second, we wanted to reuse as much as possible of the existing fixed-function units. Some embodiments reach these goals by working on smaller tiles, and deferring shading (both vertex and pixel) until last in the pipeline. The triangle traversal is replaced by sequentially scanning a sorted list of shading points.

In some aspects our architecture simplifies the pipeline. For example, during rasterization, we do not have to worry about pixel shader execution, making a streamlined implementation easier. In addition, we do not have to synchronize writes to sub-pixel locations. The added hardware cost is, of course, the addition of a stochastic rasterizer in the first place, and the introduction of a fixed-function sorting unit and associated buffers. The limitations of our architecture are largely the same as existing tiled deferred shading-based solutions (e.g., PowerVR and some game engines) are facing. Namely, that output blending and transparency is more difficult to support, and that there may be performance cliffs when too much geometry overlaps a single tile.

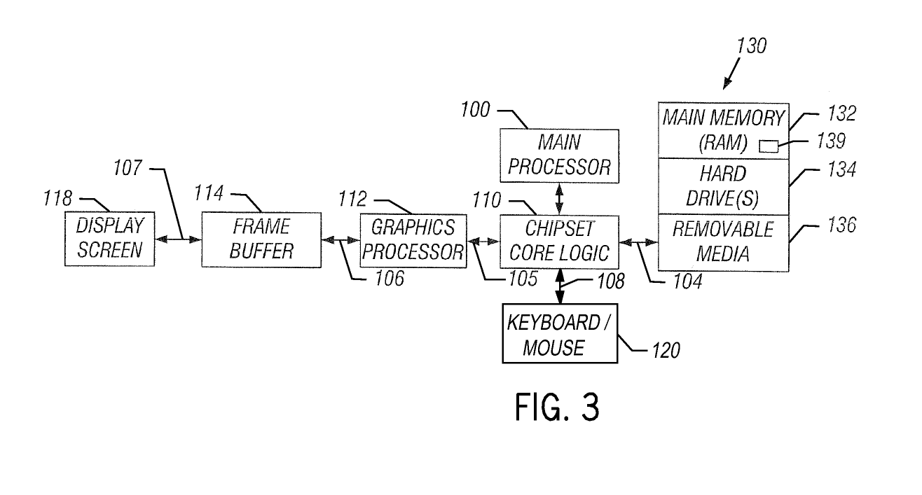

The computer system 130, shown in FIG. 3, may include a hard drive 134 and a removable medium 136, coupled by a bus 104 to a chipset core logic 110. A keyboard and mouse 120, or other conventional components, may be coupled to the chipset core logic via bus 108. The core logic may couple to the graphics processor 112, via a bus 105, and the main or host processor 100 in one embodiment. The graphics processor 112 may also be coupled by a bus 106 to a frame buffer 114. The frame buffer 114 may be coupled by a bus 107 to a display screen 118. In one embodiment, a graphics processor 112 may be a multi-threaded, multi-core parallel processor using single instruction multiple data (SIMD) architecture.

In the case of a software implementation, the pertinent code may be stored in any suitable semiconductor, magnetic, or optical memory, including the main memory 132 or any available memory within the graphics processor. Thus, in one embodiment, the code to perform the sequences of FIGS. 1 and 2 may be stored in a non-transitory machine or computer readable medium, such as the memory 132 or the graphics processor 112, and may be executed by the processor 100 or the graphics processor 112 in one embodiment.

FIG. 2 is a flow chart. In some embodiments, the sequences depicted in this flow chart may be implemented in hardware, software, and/or firmware. In a software embodiment, a non-transitory computer readable medium, such as a semiconductor memory, a magnetic memory, or an optical memory may be used to store instructions and may be executed by a processor to implement the sequences shown in FIG. 2.

The graphics processing techniques described herein may be implemented in various hardware architectures. For example, graphics functionality may be integrated within a chipset. Alternatively, a discrete graphics processor may be used. As still another embodiment, the graphics functions may be implemented by a general purpose processor, including a multicore processor.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
rasterizing, in a graphics processor, graphics primitives to generate visibility samples;
sorting visibility samples to extract coherence; and
after rasterizing and sorting, shading said primitives.

2. The method of claim 1, including storing a reference to a shading point with each visibility sample.

3. The method of claim 2, including storing a reference with a primitive identifier.

4. The method of claim 3, including storing a reference with a Morton-order shading coordinate.

5. The method of claim 2, including sorting the references to develop a list of unique shading points to be shaded.

6. The method of claim 5, including assembling groups of unique shading points;
and shading said groups of shading points.

7. The method of claim 6, including writing out shading results to each visibility sample.

8. The method of claim 1, including processing tiles representing a screen space region.

9. The method of claim 8, including generating tiles by binning primitives to the tiles they overlap, and rasterizing all primitives in a tile.

10. The method of claim 1, including rasterizing stochastically.

11. A non-transitory computer readable medium storing instructions to enable a processor to perform a method comprising:
rasterizing graphics primitives to generate visibility samples;
sorting visibility samples to extract coherence; and
after rasterizing and sorting, shading said primitives.

12. The medium of claim 11, including storing a reference to a shading point with each visibility sample.

13. The medium of claim 12, including storing a reference with a primitive identifier.

14. The medium of claim 13, including storing a reference with a Morton-order shading coordinate.

15. The medium of claim 12, including sorting the references to develop a list of unique shading points to be shaded.

16. The medium of claim 15, including assembling groups of unique shading points; and shading said groups of shading points.

17. The medium of claim 16, including writing out shading results to each visibility sample.

18. The medium of claim 11, including processing tiles representing a screen space region.

19. The medium of claim 18, including generating tiles by binning primitives to the tiles they overlap, and rasterizing all primitives in a tile.

20. The medium of claim 11, including rasterizing stochastically.

21. A apparatus comprising:
a graphics processor to rasterize graphics primitives to generate visibility samples, sort visibility samples to extract coherence, and after rasterizing and sorting, shade said primitives; and
a memory coupled to said processor.

22. The apparatus of claim 21, said processor to store a reference to a shading point with each visibility sample.

23. The apparatus of claim 22, said processor to store a reference with a primitive identifier.

24. The apparatus of claim 23, said processor to store a reference with a Morton-order shading coordinate.

25. The apparatus of claim 22, said processor to sort the references to develop a list of unique shading points to be shaded.

26. The apparatus of claim 25, said processor to assemble groups of unique shading points; and shading said groups of shading points.

27. The apparatus of claim 26, said processor to write out shading results to each visibility sample.

28. The apparatus of claim 21, said processor to process tiles representing a screen space region.

29. The apparatus of claim 28, said processor to generate tiles by binning primitives to the tiles they overlap, and rasterizing all primitives in a tile.

30. The apparatus of claim 21, said processor to rasterize stochastically.
